(19) United States
(12) Patent Application Publication
(10) Pub. No.: US 2026/0001610 A1
(43) Pub. Date: Jan. 1, 2026

(54) Lockable Bicycle Cover

(71) Applicant: Aaron Hulett, Marysville, MI (US)

(72) Inventor: Aaron Hulett, Marysville, MI (US)

(21) Appl. No.: 19/253,739

(22) Filed: Jun. 28, 2025

Related U.S. Application Data
(60) Provisional application No. 63/665,785, filed on Jun. 28, 2024.

(51) Int. Cl. B62J 19/00; B60Q 1/30; B60R 9/10; B60R 13/10

(52) U.S. Cl. CPC B62J 19/00; B60Q 1/307; B60R 13/105; B60R 9/10

(57) ABSTRACT

The present invention discloses a lockable bicycle cover that is designed to cover bicycles on a vehicle receiver hitch or on a tray mounted bicycle carrier. It features a built-in locking device for security, taillight visibility for safety, a license plate holder for legality and a weatherproof shell for protection.

### CROSS-REFERENCE TO RELATED APPLICATIONS

This application claims the benefit under 35 U.S.C. 119 (e) of U.S. Provisional Application No. 63/665,785, filed on Jun. 28, 2024.

### BACKGROUND OF THE INVENTION

### 1. Field of the Invention

The present invention relates to a vehicle mounted bicycle cover and more particularly, the invention relates to a lockable bicycle cover for transporting a bicycle on a vehicle while protecting it.

### 2. Description of the Prior Art

Vehicle mounted rack or tray transportation of bicycles has been promoted to solve the problem of carrying a bicycle to a different location. Previous attempts to cover the bicycles during transport have included bag-like protected bicycle racks and bicycle supports. However, there are certain issues that have not been addressed. A better way is needed to combat this problem. A new easy-to-use design would help the situation.

In accordance with the above-noted advantages and desires of the bicycling community, the present invention provides an improved protective design which not only gives more water resistance, but also is anti-theft and minimizes flapping more efficiently during transport. This overcomes many of the aforementioned problems.

### SUMMARY OF THE INVENTION

The present invention discloses a lockable bicycle cover that is designed to cover bicycles on a vehicle receiver hitch or on a tray mounted bicycle carrier. It features a built-in locking device for security, taillight visibility for safety, a license plate holder for legality and a weatherproof shell for protection. Sizing options are available for covering one to four bicycles along with covering and protecting the bicycle carrier itself from the elements. The new bicycle cover may be accommodated to wrap around the entire bicycle or bicycles and its carrier. It will preferably have a reusable closure at the very bottom of the cover coming to a closed point at the stem of the receiver hitch. It may preferably have three horizontal cinch straps on the vehicle-side front panel of the cover, taking up the slack of most of the material of the cover, especially if there is only one bicycle under the cover.

Most advantageously, the non-vehicle side back panel of the cover will preferably have additional cinch straps along with at least three Velcro® closure compartments with see-through plastic windows. The top two see-through plastic windows will be located near the top of the cover approximately ¾ of the way up from the bottom. They may accommodate the tail lights, as the windows will be located on the right side and on the left side of the cover. There may be a third window covering a pocket near the bottom, and in the center of the back of the cover to accommodate a license plate. Each of these three plastic windows will have a Velcro® enclosure at the top of them to render visibility of the tail lights and the license plate. This design will most preferably be heavy duty and be able to withstand extreme abuse from weather and high winds. Vehicles will be traveling at highway speeds for sustained periods of time.

### BRIEF DESCRIPTION OF DRAWINGS

For a further understanding of the nature and advantages of the expected scope and various aspects of the present invention, reference shall be made to the following detailed description, and when taken in conjunction with the accompanying drawings, in which like parts are given the same reference numerals, and wherein:

FIG. 1 is a perspective view of the bicycle cover being made in accordance with the present invention;

FIG. 2 illustrates a front-elevational view showing the respective placement of windows showing license plate and tail light positions;

FIG. 3. is a rear-elevational view of the bicycle cover showing securing straps;

FIG. 4 is a top-plan view of the bicycle cover showing tie-down straps;

FIG. 5 is a side-elevational view of the bicycle cover of the present invention; and

FIG. 6 is a rear-elevational view of the bicycle cover showing securing straps.

### DETAILED DESCRIPTION OF THE INVENTION

In a preferred aspect, attached cinch straps are employed to secure the lockable bicycle cover to the vehicle and its hitch. Preferably, these cinch straps will be a minimum of two inches wide although any straps that work will be acceptable. They could advantageously be nylon straps with cinch buckles. They may be flared out with material behind the cover to strengthen its contact point area. This will ensure durability and provide tension being spread over a wider area. Preferably, there will be up to ten (10) cinch straps on the bicycle cover. For example, one to three cinch straps may be on the front of the cover. They can be 2 inches wide and run horizontally across the width of the cover. Bottom cinch straps can be approximately 20% up from the bottom, while additional cinch straps may be in the middle of the cover, and a third horizontal cinch strap would also be 20% below the top of the cover.

In an aspect such as this, there may be four and/or five cinch straps located on the back of the bicycle cover, run down from the top to the bottom of the cover. At the top, they would be behind the bicycle seat of the bicycle being carried, which would be on one side, and just in front of the handlebars on the other side. Two sizing options will be available. The first aspect of the present invention is for covering one to two bicycles while a second aspect is for covering three to four bicycles. Cinch straps six and seven may be located on the very top of the cover. The cinch straps would go from the front to the back of the bicycle cover to be able to cinch down loose material on the handle bar and seat of the bicycle. Cinch strap eight would run horizontally and be located on the back of the cover, near the top, so that it is positioned to cinch down any loose material surrounding the seat and handlebars would become tightened down. Cinch straps nine and ten would be located on the back of the cover, and they would hold down the flap that would be covering a locking device.

The opening of the bicycle cover would preferably be the entire bottom of the cover. It will open and close using a heavy duty drawstring or any other suitable closing device. The drawstring may have a locking device or cinch down mechanism in the drawstring, so that it stays closed. Any excess cord may be wrapped around the hitch arm and be secured by a securement band to ensure that the cord is not dragging on the road while in transit. Each cinch strap could have a perpendicular Velcro® wrap to secure any loose strapping, in order to stop it from flapping in the wind.

In order to secure the bicycle cover, a wide channel is preferably sewn to the outside of the cover, in a crisscrossing X-shaped pattern. Vinyl coated locking cables and lights are preferably adapted to run through the channels. The channel would be most advantageously about three inches wide at a minimum to allow for ease. This is to eliminate any binding when the cover is cinched down, and it will aid in removing the tail lights and cables to clean the cover. The lights will run from the plastic windows that house the tail lights on the back of the cover through the X-shaped channel that is sewn into the outside of the cover down to an opening on the bottom. The cord to the light can then be running from the bottom to the plug-in on the vehicle. Preferably the two locking devices meet at the same point which will be approximately a 1′×1′ area on the front of the cover. A flap is adapted to cover them there. The flap would optimally have two small cinch straps located at 45° angles to keep the flap taught in the wind. The cables wrap around the bottom of the cover, and will be open and exposed in that small area. The cables will be fed back up through the X-shaped channel and then into a locking area. In a preferred aspect of the present invention, in order to lock the cover, will include the master lock python in-line cable lock, at an approximate eight foot length.

Optional lighting may be advantageous, and preferably, would be using a commercially available product by a company called Curt, including their 1″×7″ LED auxiliary light. Wires for the lights would run through the exterior channel in the cover. This is the same channel where the vinyl coated locking cables will run through. In one aspect, the wiring will be encapsulated in a corrugated plastic tubing to ensure that no wires are pinched when in transit or when the cover is being secured down. They will need to be in an opening in the channel so that the tail lighting can be plugged and unplugged. The tail lighting will need to be removable so that the cover can be machine washed.

Although the invention will be described by way of examples herein below for specific aspects having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different aspects and its details are capable of modifications of various aspects which will be obvious to those of ordinary skill in the art all without departing from the spirit of the present invention. Accordingly, the rest of the description will be regarded as illustrative rather than restrictive.

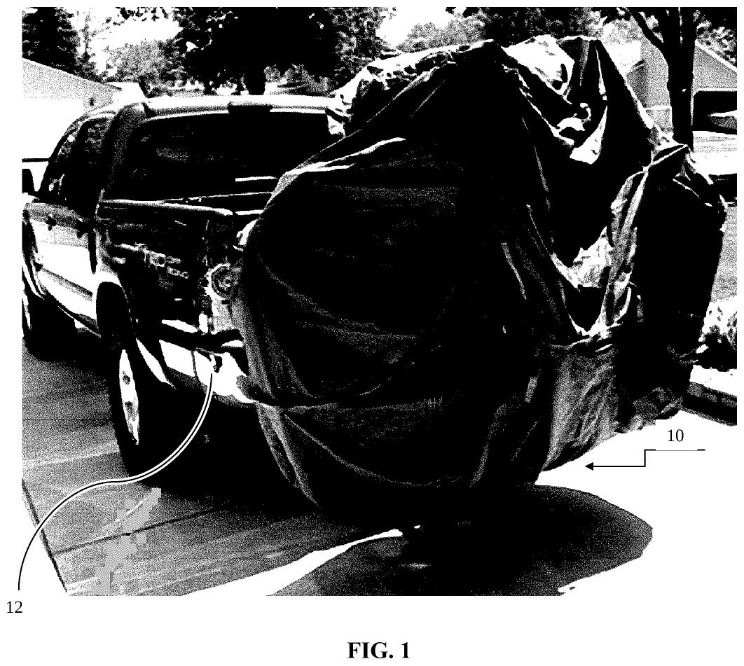

Referring now to the drawings in detail, FIG. 1 is a perspective view of the instant bicycle cover generally denoted by numeral 10 attached to the rear of vehicle 12 to show the relative placement where bicycle cover 10 will be cinched down to more tightly cover its bicycle to avoid flapping during transport. In a first aspect, a basic cover is designed to simultaneously cover two bicycles and the vehicle mounted bicycle carrier. Sizes can be reduced or increased to accommodate less or more bicycles. Additional cover sizing will also accommodate smaller or larger frames.

The bicycle cover will preferably be made of 600 denier solution dyed polyester fabric with a durable water repellent coating (DWR); such as a DWR coating that is preferably black or dark gray to defray dirt. The DWR coating is preferably heavily water repellent. The solution dyed polyester material would also include UV stabilizers to resist fading from the sun.

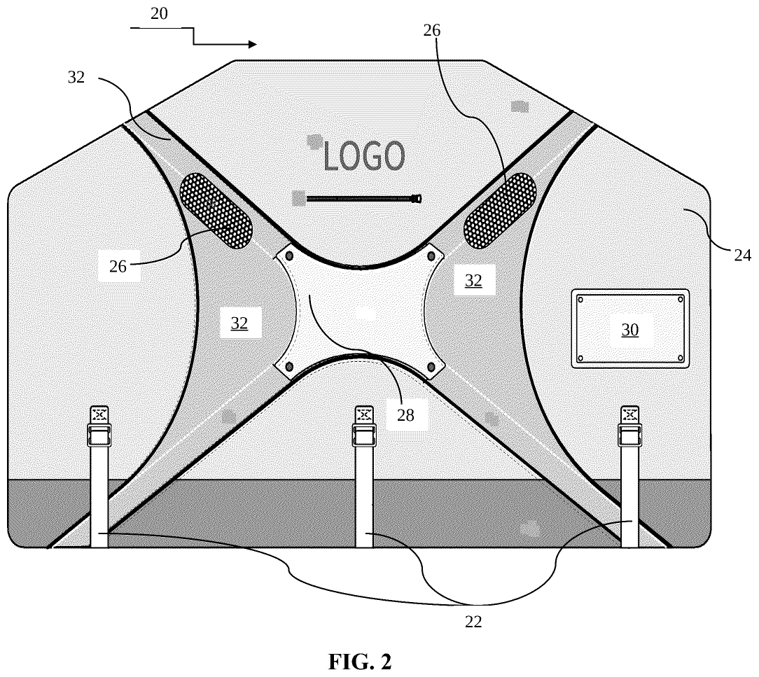

FIG. 2 is a front-elevational view of the bicycle cover made in accordance with a preferred aspect of the present invention. In this aspect, the bicycle cover is generally denoted by numeral 20 including tie-down cinch straps 22 that will provide closure for an integrated roll closure. This enables the bicycle cover to be slipped over the bicycle(s) and securely fastens bicycle cover 20 to alleviate flapping during transport. Cover flaps 24 are preferably made of a suitable material of from 200 to 2,000 denier polyester with a water proof polyurethane coating, preferably a 1,200 denier material, extending from side to side. Cover flaps 24 are sewn together between front and rear panels of the bicycle cover to enable one to slip the bicycle cover over the top of the bicycle or bicycles to be contained therein. As such, the opening for bicycle cover 20 is on the bottom which forms the integrated roll closure and is secured by at least one roll top cinch strap and buckle adjustment 22 in order to secure rolled fabric of the bicycle cover fabric. Reflectors 26 may be outwardly extending from an upper portion of X-shaped channel 32 sewn on top of cover flaps 24 to receive an optional cable lock or strap. An optional printed central logo may be placed for advertisement purposes on any portion of flaps 24. In addition, an optional zipper underneath the logo placement acts as an opening for an internal cover access to an optional pocket to hold keys, rain gear, etc. Also included may be an internal license plate pocket 30 with a clear vinyl window for visibility for legal compliance.

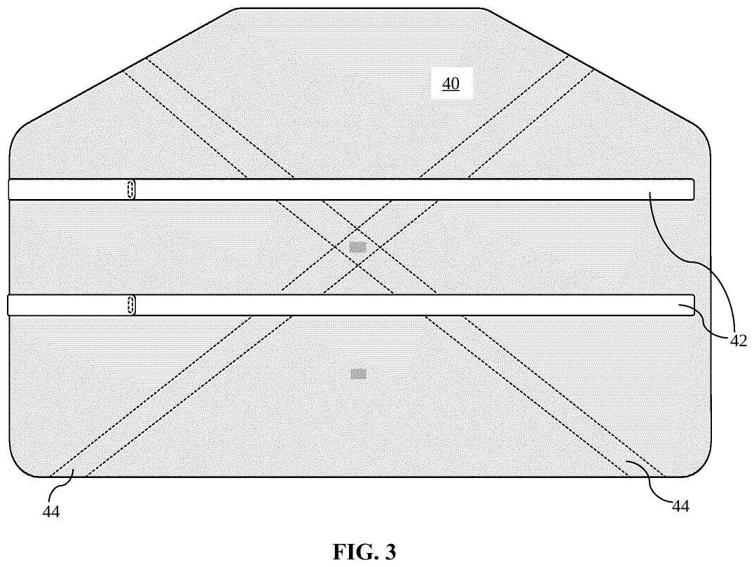

FIG. 3 is a rear-elevational view of an aspect of the present bicycle cover made in accordance with the present invention, wherein flap cover 40 includes top cinch strap and buckle adjustments 42 used to cinch down and tightened side flaps to enclose and encapsulate a bicycle within the bicycle cover. Shown in phantom, X-shaped channel 44 is useful for guiding a cable lock or strap, optionally usable for security purposes.

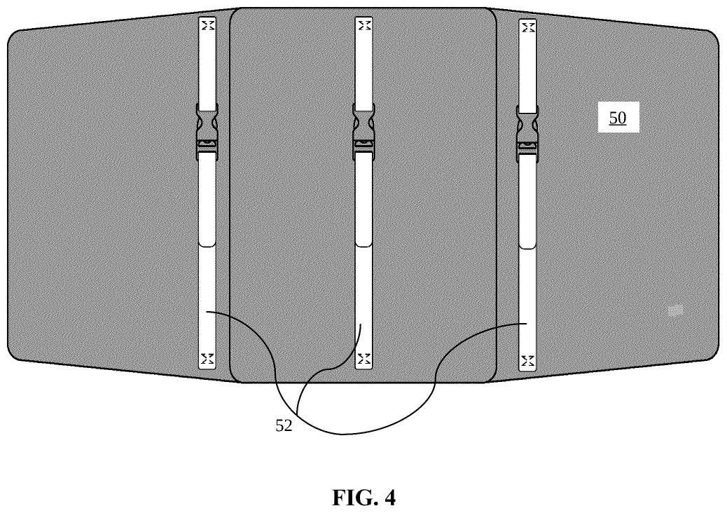

Looking next to FIG. 4, shown is a top-plan view illustrating the relative placement of cinch straps 52 useful for accommodating either at least one bicycle or a number of bicycles.

These straps constrict the width of the cover 50 accommodating either at least one bicycle or a number of bicycles. This also allows the cover to accommodate varying widths of bicycles as well. Furthermore, it connects to the lower roll closure straps noted in FIG. 3. These straps allow the cover to be compressed from bottom up to the top, eliminating any unnecessary movement in the covers material while traveling. They also secure the closure of the cover.

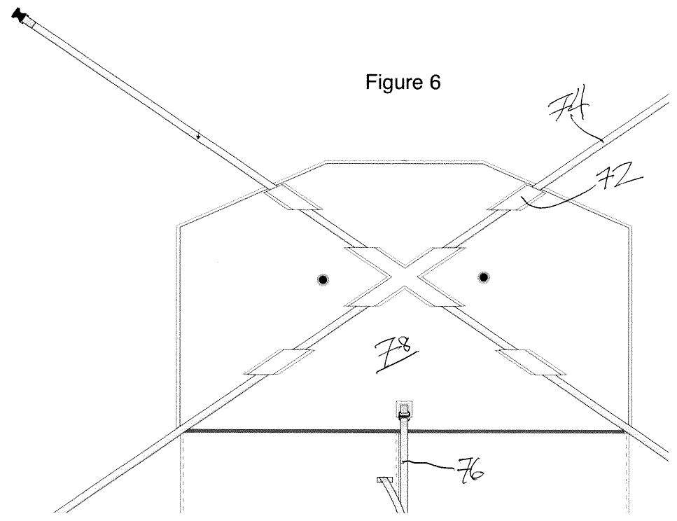

Lastly FIG. 6 shows in detail how the cinching straps 74 wrap around the cover in the X-shaped channels 72 on cover 78. A cinching strap 76 cinches the bottom of the cover 78.

In order to provide tail lights, additional LED lights or any similar type of lighting devices may include attached electrical connectors to plug into the electrical sockets at the rear of the vehicle transporting its bicycle cargo. In order to make the license plate visible, the license plate may be removed from the vehicle and situated within the clear window pocket of FIG. 2. Further lighting and license plate details may be optionally added as desired, depending on local regulations. The inventor also envisions providing see through mesh and or plastic windows so that the tail lights and license plate of the vehicle may be secured and free from excessive movement from travel.

It should also be noted that the present design will cover and will also protect the bicycle carrier or bicycle tray itself. An example of a useful locking device may include the Python by Master Lock®, or the Steelcore® locking strap, etc.

The present invention may include pockets designed to support a tail light system that can be connected to the vehicle to provide lighting and safety. Furthermore, air valves will be located in multiple sections of the cover allowing air to pass through the cover FIG. 2. This will help eliminate moisture build up on the inside of the cover. There may also include optional reflective stitching or patches on the sides and back of the cover for visibility and safety.

The dimensions are approximately 84″ in width and 82″ in height for the cover that accommodates 1-2 bicycles. Any useful material is preferably heavy duty, UV fade resistant and waterproof. The inside of the material shall not scratch the bicycle paint. One option is a 600 D solution dyed polyester with a waterproof backing or coating, preferably black or dark gray, as not to show road grime. Solution dyed materials resist fading from the sun. Suitable characteristics may include materials that are extremely resistant to UV fading, extremely durable; abrasion and tear resistant, minimally abrasive on the interior so that the cover cannot scratch the bicycle paint, waterproof or with a waterproof coating, mildew resistant and quick drying.

Cinching straps are preferred and may be nylon cinch straps with cinch buckles. Any contact points between bicycle and cover will be strengthened at the contact point areas. This will ensure durability and spread stress and rubbing over a wider area. It has been found there will be optimally eight cinch straps in total on the bicycle cover. Three cinch straps will be located on the top of the cover. Additionally, in this aspect, three will be located at the bottom of the cover. Two of the bottom straps will connect to the two outside straps at the top of the cover. The final two straps are placed in X-shaped channels, allowing them to wrap around the cover. In this design, the user can secure every area of the cover. It would be important to be able to easily loosen and tighten these straps from all sides of the cover.

The lower closure strap buckle allows the user to enclose the cover around the hitch receiver. This area may have Velcro® to assist in aligning the front and back of the cover to make it easier for the user to roll it closed at the bottom. This closure at the bottom will also ensure that no road spray that comes up from the bottom. The opening will be the entire bottom of the cover, similar to a large common barbecue grill cover.

Each cinch strap will preferably have a strap keeper such as a small Velcro® wrap sewn on to the end of each cinch strap. These small Velcro® strap keepers are perpendicular to the cinching strap, thereby allowing for securing of loose straps, in order to alleviate any flapping in the wind or dragging on the ground.

Regarding locking the bicycle cover, a wide channel is preferably sewn to the outside of the cover, in an X-shaped pattern that allows vinyl coated locking cables or similar locking straps and lights to run through the wide channel. The X-shaped channel will be most useful at approximately three inches or more wide. This is to alleviate any binding when the cover is cinched down, and it will aid in easily removing the lights and cables to clean the cover if needed.

In an aspect of the present invention, wiring needed for legal running lights will run from the mesh windows that house the running lights on the back through the X-shaped channel that is sewn into the outside of the cover. Wiring for the lights will run from those sewn on mesh pockets through the X-shaped channels and ultimately into the vehicles, trailer or auxiliary lighting system. Those channels will have a slotted opening to allow the lights to enter the channel.

Another aspect may be accomplished with any suitable light, such as an LED light, like a product by a company called Nilight™, a Trademark of Nilight Company. This light includes a 6″ red oval, waterproof LED auxiliary light suitable for the road. There will be two housing areas for the lights, one for the right blinker/tail light, and one for the left blinker/tail light.

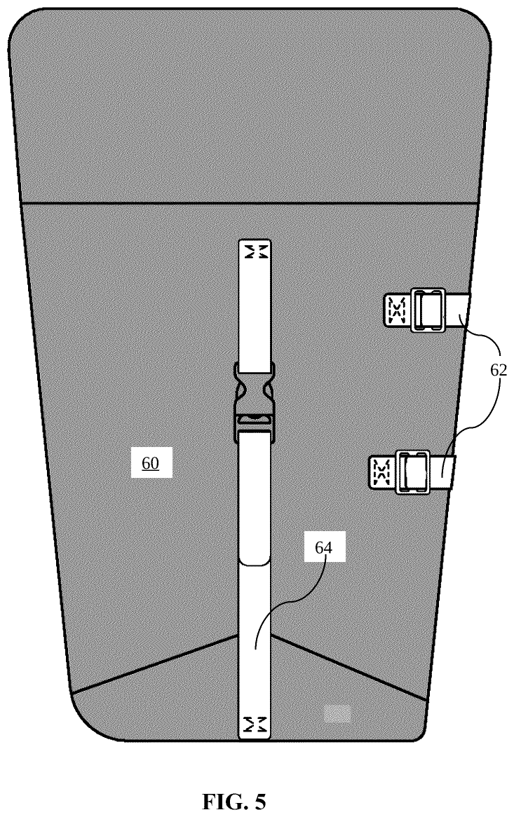

FIG. 5 is a side-elevational view of the present invention showing the relative location of side flap 60 having cinch straps 62. The bicycle cover closes from the bottom in a roll closure, similar to a roll top duffel bag. There will be a strap on each side of the cover at the bottom, connected to the side of the roll closure cinching them upward. This will secure it from moving or flapping in the wind. Side roll top cinch strap and buckle adjustment 64 is used to secure roll fabric to accommodate a smaller number of bicycles. Upper portion 66 is wider than bottom portion 68 in order to accommodate the handlebars of any bicycle or bicycles loaded thereon.

Preferred materials used to manufacture the bicycle cover of the present invention not only include low denier polyester, but may also be selected from a group consisting of waterproof materials, stretchable materials and may optionally include a cotton or fleece lining to prevent scratching of the bicycles. Any of these materials may be one or multiple layer construction. Further, any suitable coating may be employed to achieve any desired property, bicycles may include locking devices extended through the X-shaped channel shown in FIGS. 2 and 3, and may include anti-theft cables and any similar materials commercially available for bicycle security. The present invention is also preferably heavily water-resistant, cutting down on any damage to the bicycles being transported, keeping them clean for use once arrived at its destination.

In order to provide tail lights, additional LED lights or any similar type of lighting devices may include attached electrical connectors to plug into the electrical sockets at the rear of the vehicle transporting its bicycle cargo. In order to make the license plate visible, the license plate may be removed from the vehicle and situated within the clear window pocket of FIG. 2. Further lighting and license plate details may be optionally added as desired, depending on local regulations. The inventor also envisions providing see through plastic windows so that the tail light and license plate of the vehicle may be secured without relocation.

Anti-theft and/or locking devices may be included to help provide securement from thieves if one parks the vehicle and goes into a store, for example. Because the present invention is suitable for a number of bicycles, it should also be noted that the present design will cover and will also protect the bicycle carrier or bicycle tray itself. An example of a useful locking device may include the Python by Master Lock®, etc.

The present invention may include pockets designed to support a tail light system that can be connected to the vehicle to provide additional lighting and safety. The inventor herein also envisions that this bicycle cover may be comprised of multiple pieces, specifically designed for covering particular components of the bicycle. Such a completed cover may include zippers, Velcro® or other suitable means of attachment at all locations of the individual multiple pieces. This may allow the bicycle to be easily inserted to provide full coverage. For example, after the bicycle is securely in place, closing the zipper, Velcro® or other means of attachment will snugly be secured about the bicycle. Furthermore, one or more sections may be comprised of a mesh-like material which will allow for air passage in order to allow air to pass through to the bicycle such that flapping of the bicycle cover is kept to a minimum.

A preferred aspect includes a built-in locking device for security, tail lights for safety, a license plate holder for legality and a heavy duty weatherproof shell for protection. Other vandalism and weather damage concerns can be alleviated while parked, which would include the cable locks to be extended outwardly to allow the owner of the bicycle to lock up his bicycle to a stationary item nearby, such as a post, railing or the like. Although any suitable cable lock may be employed, a preferred lock will be the Master Lock Python™ in-line cable lock, available from Master Lock Company, LLC, at an approximately 6-8 foot length. One lock may be run through both channels on the cover.

A license plate may be held in a plastic see-through pocket with a Velcro® enclosure at the top to hold it in place. To comply with regulations, the pocket is 6.250 inches tall by 12.250 inches wide to meet legal standards. There may also include optional reflective patches on the sides and back of the cover.

There will preferably be three horizontal cinch straps on the front of the vehicle side cover. This will take up any existing slack of most of the material of the cover, especially if there is only one bicycle under the cover. The back of the cover, ie. non-vehicle side, will have preferably three Velcro® compartments with see-through plastic windows. The top two windows will be located near the top of the cover approximately ¾ of the way up from the bottom. They will accommodate the tail lights as one will be located on the right side, while the other window will be on the left side of the cover. There will be a third window near the bottom, and in the center of the back of the cover. This third window will accommodate a license plate. Each of these three plastic windows will have a Velcro® enclosure to secure and or install and remove the tail lights and license plate.

This invention includes a lockable bicycle cover that is designed to cover at least one bicycle on a receiver hitch or a tray mounted bicycle carrier. Preferably, the present bicycle cover will accommodate up to two large size bicycles and most smaller bicycles as well. The dimensions are 80″ length×48″ high×30″ length at the top and depth is 36″ at the top that tappers down to 20″ at the bottom.

Any useful material is preferably heavy duty, UV fade resistant and waterproof. The inside of the material cannot be too course so that it will not scratch the bicycle paint. One option is a 600 D solution dyed polyester with a waterproof backing or coating, preferably black or dark gray, as not to show road grime. Solution dyed materials resist fading from the sun. Suitable characteristics may include materials that are extremely resistant to UV fading, extremely durable; abrasion and tear resistant, minimally abrasive on the interior so that the cover cannot scratch the bicycle paint, waterproof or with a waterproof coating, mildew resistant and quick drying.

Cinch straps are preferred and may be nylon cinch straps with cinch buckles. Any contact points between bicycle and cover will be strengthened at the contact point areas. This will ensure durability and spread stress and rubbing over a wider area. It has been found there will be optimally five cinch straps in total on the bicycle cover. Three cinch straps will be located on the front of the cover. The anchoring points for the beginning, and ending of the cinch straps will be on the side of the bike cover. In this design, the user does not have to get between the cover and the vehicle to secure the straps, as they need to be able to secure the straps from the side of the cover. This will also aid in tightening the cover when there is additional loose material when traveling with one small bike. It would be important to be able to easily loosen and tighten these straps from the side of the cover. Two more cinch straps will preferably be located on the top of the cover, going from front to back to be able to cinch down any loose material over the handle bar and or seat of the bicycle. In an aspect of the present invention, enclosing the bottom of the bicycle cover around the hitch of the vehicle preferably includes a large heavy Velcro® cinch strap, Speedwrap style, that has a sewn in line channel encasing a 4″×2.25″ wide consecutive loop placed to secure the cover around the stem of the hitch receiver. The line of consecutive belt loops allows the user to secure the cover around the hitch at different lengths up or down the cover. When transporting one bicycle, there will inevitably be a certain amount of loose material, and the line of belt loops allows the user to enclose the cover around the hitch receiver at a slightly higher point. This disclosed combination of a Velcro® strap with a loop, will secure the closure and seal it up from any road spray that comes up from the bottom. Reflective loops, built into the cover itself, may be employed to aid in night time installation. The opening will be the entire bottom of the cover, similar to a large common barbecue grill cover.

Each cinch strap will preferably have a strap keeper such as a small Velcro® wrap sewn on to the end of each cinch strap. These small Velcro® strap keepers are perpendicular to the cinch strap thereby allowing for securing of loose cinch straps, in order to alleviate any flapping in the wind or dragging on the ground.

Regarding locking the bicycle cover, a wide channel is preferably sewn to the outside of the cover, in an X-shaped pattern that allows vinyl coated locking cables and lights to run through the wide channel. The X-shaped channel will be most useful at approximately three inches wide. This is to alleviate any binding when the cover is cinched down, and it will aid in easily removing the lights and cables to clean the cover if needed.

In an aspect of the present invention, wiring needed for legal running lights will run from the plastic windows that house the running lights on the back through the X-shaped channel that is sewn into the outside of the cover. Wiring for the lights are preferably enclosed in the round non-collapsing corrugated plastic, running from the bottom to the electrical plug-in on the vehicle. The cable lock will run through one of the sewn in channels and the lights will run through the other, meeting at the “X” intersection point, which will be approximately a 6″×6″ open area on the back of the cover. Although there will be no actual opening in the cover itself, but rather only creating approximately a 6 inch gap from one channel to the other channel. This area will be used to secure the lights and to lock and unlock the cable locking device. Four small sturdy Velcro® straps will preferably be used in this area, one on each tail light, and one each on the entry and exit points where cables that go into and out of the locking device itself. These four Velcro straps will keep the lights in place and minimize road movement from the weight of the lock.

Another aspect may be accomplished with any suitable light, such as an LED light, like a product by a company called Nilight™, a Trademark of Nilight Company. This light includes a 6″ red oval, waterproof LED auxiliary light suitable for the road. The wires for the LED lights will run through the channels built into the exterior of the cover. The wiring can be encapsulated in a corrugated plastic tubing to ensure that no wires are pinched when in transit or when the cover is being secured down. An opening in the channel allows the lighting to be inserted into its housing area. There will be two housing areas for the lights, one for the right blinker/tail light, and one for the left blinker/tail light. A Velcro® opening may be utilized so that the lights can slide into their housing area. The Velcro® straps will help hold the lights in place during transit and high winds.

In summary, numerous benefits have been described which result from employing any or all of the concepts and the features of the various specific aspects of the present invention, or those that are within the scope of the invention. The present invention acts perfectly to achieve all these goals.

The foregoing description of a preferred aspect of the invention has been presented for purposes of illustration and description. It is not intended to be exhaustive or to limit the invention to the precise form disclosed. Obvious modifications or variations are possible in light of the above teachings with regards to the specific aspects. The aspect was chosen and described in order to best illustrate the principles of the invention and its practical applications to thereby enable one of ordinary skill in the art to best utilize the invention in various aspects and with various modifications as are suited to the particular use contemplated. It is intended that the scope of the invention be defined by the claims which are appended hereto.

1. A bicycle cover, comprising a weatherproof lockable bicycle cover for covering at least one bicycle and bicycle carrier; a visibility device for tail lights; and a license plate holder for legality.
